(19) United States
(12) Patent Application Publication
(10) Pub. No.: US 2004/0093378 A1
(43) Pub. Date: May 13, 2004

(54) Internet document creation system

(76) Inventor: Kevin L. Warnock, San Francisco, CA (US)

Correspondence Address: WINSTON & STRAWN, PATENT DEPARTMENT, 1400 L STREET, N.W., WASHINGTON, DC, 20005-3502, US

(21) Appl. No.: 10/700,898

(22) Filed: Nov. 3, 2003

Related U.S. Application Data
(63) Continuation of application No. 09/457,149, filed on Dec. 8, 1999, now abandoned.

(51) Int. Cl. G06F 15/16

(52) U.S. Cl. 709/203; 709/205

(57) ABSTRACT

A document creation system for providing an Internet service in which users with browsers at remote locations can look for an appropriate document and format. Such user fills-in-the-blanks and is returned a custom electronic document that can be printed or forwarded to another recipient. A document-creation webserver attends to Internet browsers who log-on and look for a product. Such users are qualified and handed-off to a job-master webserver. The hand-off provides metadata that was collected from the user, and schedules the job for the next available document processor. The jobs and metadata are stored in a database. Master documents are stored on disk. The document processor assigned to do the job collects the metadata from the database using a pointer provided in a job queue, and fetches a copy of the appropriate master document. The blanks in the master document copy are filled in using the metadata and/or other data, perhaps from a database, and the completed document is returned to the customer over the Internet. A backend local area network is used to provide a backbone for scaling larger document processor capacities in a modular fashion. Each document processor is deliberately put to sleep for 100 milliseconds each time it finds no job is waiting to be done in the queue, so as to reduce network congestion and improve system performance.

### CROSS-REFERENCE TO RELATED PATENT APPLICATION

This is a continuation application of U.S. patent application Ser. No. 09/457,149, filed Dec. 8, 1999, which is hereby incorporated herein in its entirety.

### BACKGROUND OF THE INVENTION

1. Field of the Invention

The present invention relates to Internet equipment and services, and more particularly to remotely creating and returning completed documents to Internet users who have filled out answers to various questions on a job-input form.

2. Description of Related Art

It often happens that people and companies have to write the same basic kinds of letters and fill out the same kinds of forms over and over. Some word processing programs and slide presentation programs provide templates for common formats, e.g., business letters, personal letters, etc. People and companies that have to write some kinds of letters only once or twice often have to write them the way that others have. Hallmark, and other greeting card companies have made quite a business out of eloquently expressing greetings, congratulations, and condolences better than the average person. So preprinted cards with appropriate pictures and a message are bought by millions, and then signed and sent along to the recipient.

Businesses typically have many kinds of form letters that they routinely compose and mail to customers, suppliers, government agencies, and other co-workers. In such situations, it would be advantageous if company policies and legal requirements could be consistently adhered to.

The Judicial Council of California promulgates various court filing forms that are recommended or required for certain California Court filings. The latest revisions and correct use can be difficult for lay people and even small law firms to keep up with. Electronic forms on disk are available, but these are expensive and become obsolete quickly if subscription upgrades are not also purchased.

The Internet now presents a new media by which even one-time users can take advantage of the highest quality and most up-to-date forms and letters for a very wide spectrum of purposes.

### SUMMARY OF THE INVENTION

An object of the present invention is to provide a document-creation system that can be accessed by many user over the Internet.

Another object of the present invention is to provide a document creation system that allows users to simply and quickly choose the appropriate document format and then supply the information needed to “fill-in the blanks”.

A further object of the present invention is to provide an Internet document creation system that is readily scaleable.

A still further object of the present invention is to provide an Internet document creation system that is assembled from common hardware and software components.

Briefly, an Internet document creation system embodiment of the present invention comprises a website that receives information from a user needed to fill out a standardized form document, and then generates a completed ready-to-use document that is sent to the user or the user's intended recipients. Such information may also be stored ahead of time in a database, so the user doesn't need to supply some answers while on-line. The website comprises a computer platform that interfaces to the Internet with Microsoft. Internet information server (IIS) running under a Windows-NT operating system. Application programs like Microsoft WORD97 are made to operate as an NT-service by interfacing it with Microsoft SRVANY to the Windows-NT.

An advantage of the present invention is that a document-creation system is provided that is quick and expandable.

Another advantage of the present invention is that more document-creation processors can be added as modular units to a base system.

A still further advantage of the present invention is that a document creation system is provided that allows users to simply and quickly choose an appropriate document format, and then supply the information needed to “fill-in the blanks”.

The above and still further objects, features, and advantages of the present invention will become apparent upon consideration of the following detailed description of specific embodiments thereof, especially when taken in conjunction with the accompanying drawing.

### BRIEF DESCRIPTION OF THE DRAWINGS

FIG. 1 illustrates a document-creation system embodiment of the present invention.

### DETAILED DESCRIPTION OF THE INVENTION

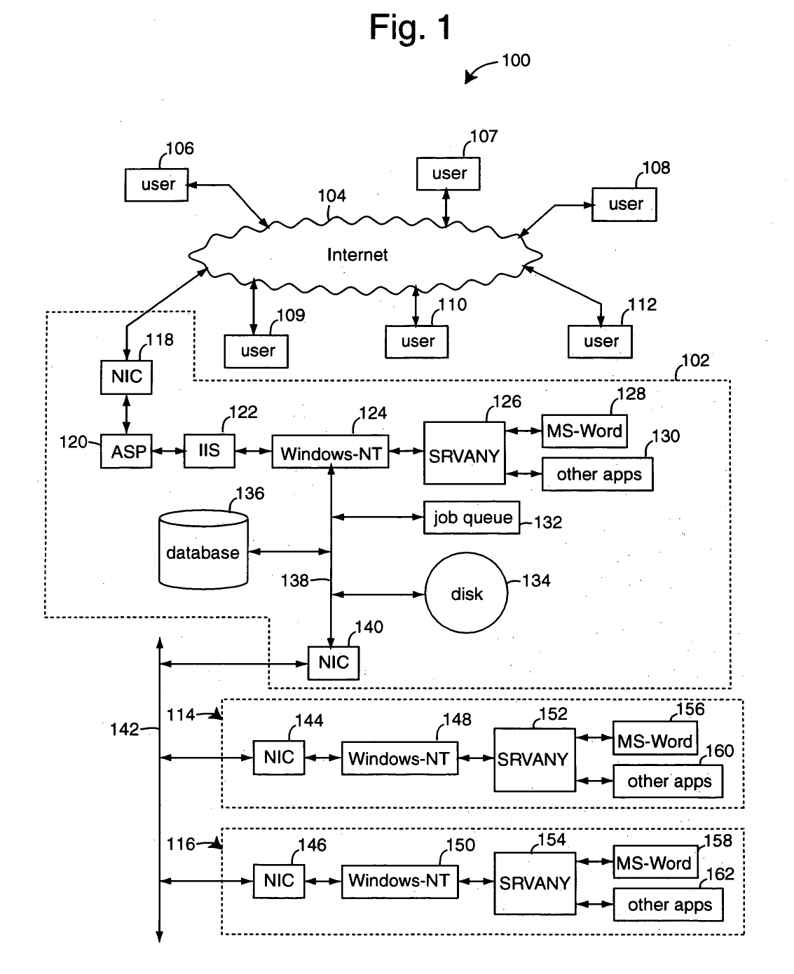

FIG. 1 illustrates an Internet document creation system embodiment of the present invention, referred to herein by the reference numeral 100. The system 100 comprises a webserver 102 connected to the Internet 104 and many clients or users 106-112. A pair of system-expansion units 114 and 116 modularly increase the ability of webserver 102 to create documents at the requests of users 106-112.

The webserver 102 interfaces to the Internet 104 with a network interface controller 118. An interactive webpage user interface 120 provides functionality similar to Microsoft Corporation (Redmond, Wash.) Active Server Pages (ASP). An Internet file and application server 122, such as Microsoft Internet Information Server (IIS), runs under control of an operating system 124. Microsoft Windows-NT server is preferably used for the operating system 124. A utility 126 is used to present a wordprocessor program 128 as a service that is available under Windows-NT. For example, SRVANY, as provided my Microsoft as file srvany.exe in the NT-Resource Kit, can be used for the utility 126. Microsoft WORD-97 can be used for the wordprocessor program 128. The SRVANY utility 126 may also be used to run other application programs, e.g., application 130, as Windows-NT services.

Microsoft Windows-NT services are processes that run without requiring a user to be logged on to the system, e.g., Microsoft SQL Server, Microsoft Exchange Server, Dynamic Host Interface Protocol (DHCP), and even Windows Internet Name Service (WINS) servers.

According to Microsoft, the srvany.exe utility allows applications to be run as windows-NT services. This allows applications to survive logoff/logon sequences, and save the re-starting overheads for each new user. Server applications can come-up and service requests even when no user is logged-on. Applications can run and do a task in a specific logon account, different from the currently logged-on user. This ability to run tasks under a specified logon account expands the scope of what can be accomplished with Word 97 and other word processing software programs. For example, it is much more practical and easy to create Adobe PDF files when running under a named account rather than the so-called Local System account that services run as by default. Some applications may terminate upon logoff, even though they were started as a service, if they don't ignore the wm_endsession message, or ctrl_logoff_event.

A job queue 132 is periodically consulted by the wordprocessor program 128 and other application program 130 to see if there are any jobs pending. A so-called “macro” program can be written with the MS-Word application that will do such job queue checking, e.g. as in Table I. Such macros may be written using Microsoft Visual Basic for Applications. Macro functionality may also be achieved by writing Dynamic Link Libraries (DLLs) that may be invoked from Word. DLLs typically run faster than regular macros. If no job is pending, the macro-program is preferably written to call an API-system function that will put the wordprocessor program 128 or other application program 130 to sleep for a short time. Prototypes that have been built indicate that a sleep-time of one hundred milliseconds produces good results. When the API-system function allows the wordprocessor program 128 or other application program 130 to wake-up, the job queue 132 is checked again. Note that it is not a requirement for the word processing program to be “put to sleep,” however this sleep period reduces network traffic and improves performance in the aggregate.

TABLE I
Word Macro

```
‘ copyright (c) 1999 by Kevin L. Warnock
Declare Function Beep& Lib “kerne132” (ByVal dwFreq As Long, ByVal dwDuration As
Long)
Declare Sub Sleep Lib “kerne132.d11” (ByVal dwMilliseconds As Long)
Sub hot( )
‘
‘hot Macro
‘Macro created 01/30/99 by Kevin L. Warnock
‘This macro is started by automatically when NT boots, provided Word 97 is set up with
SRVANY.EXE, a utility that ships with the NT Resource Kit from Microsoft. This macro
uses a COM object (Hotworker.Cluster) to determine if there is work to be done. If there
is work, the DraftHot function is called, otherwise, this macro goes to sleep via the WIn32
api call “sleep.” During this time, essentially no CPU time is used.
On Error GoTo err_hot
    Dim ret, i, strSwitch, status, InvokeWord, WorkPath, DelimitedData
    Dim objCluster As Object
    ‘Set value to 1 so that loop will run at least once.
    strSwitch = “1”
      ‘Create Hotpaper Cluster object.
      Set objCluster = CreateObject(“Hotworker.Cluster”)
Do While strSwitch=“1”
‘Create document by calling method.
ret=objCluster. ReadFromCluster(“Compaq NT Server”)
Select Case ret
Case “draft”
‘Draft document.
status=drafthot(objCluster.MasterDoc, objCluster. ResultDoc,
objCluster. ResultDOcIC, objCluster. DSN, objCluster.WorkPath,
objCluster.Field1, objCluster.Field2, objCluster.Field3, objCluster.Field4)
‘Now implement 2nd phase of two phase commit.
ret = objCluster.StatusCluster(objCluster.WorkKey)
Beep 1500, 100
DoEvents
Case “idle”
  Sleep 100
  DoEvents
End Select
‘See if macro should continue by checking switch text file on disk.
‘1 = run, 0 = stop.
Open “c:\temp\s\s.txt” For Input As #1
Input #1, strSwitch
Close #1
Loop
  ‘Release object.
  Set objCluster = Nothing
err_hot:
  Debug.Print “Error: ” & Err.Description & “ Number: ” & Err.Number
End Sub
Function drafthot(MasterDoc, ResultDoc, ResultDOClD, DSN, SQL, WorkPath, Field 1,
Field2, Field3, Field4)
    ‘This macro actually creates the Word 97 document.
35
On Error GoTo Err_drafthot
Dim strMsg, DSNstring, PhysicalPath, SaveFormat, ReturnValue
‘Change directory to where masters are kept.
ChangeFileOpenDirectory WorkPath
strMsg = strMsg & “3. Changed directory to where masters are kept. Time: ” & Now
& vbCrLf
‘Open master Microsoft Word 97 document without text datasource attached.
‘Note that users may not have any System DSN text drivers installed on the NT Server
‘if users want to dynamically attach a text datasource. If users do, a dialog will pop
‘up asking users to select which driver to use. This dialog will hang Word and break
this app.
  ‘In this case, just attach the datasource to the master Word document and save it. That
will
  ‘work fine, but users lose the ability to change the application location since the
datasource
  ‘is hardcoded into the master document.
  Documents.Open FileName:=MasterDoc, ReadOnly:=True
‘Attach SQL Server datasource.
ActiveDocument.MailMerge.OpenDataSource names: _{—}
“”, ConfirmConversions:=False, _{—}
Read Only: =False, LinkToSource:=True, AddToRecentFiles:=False, _{—}
PasswordDocument:=“”, PasswordTemplate:=“”, WritePasswordDocument:=“”, _{—}
WritePasswordTemplate:=“”, Revert:=False, Format:=wdOpenFormatAuto, _{—}
Connection:=“DSN=” & DSN & “;”, SQLStatement:=SQL, SQLStatement1:=“”
‘Capture physical path where we will later save file.
PhysicalPath = ActiveDocument.MailMerge.DataSource.DataFields(“PhysicalPath_”)
‘Capture format user requested the file be saved as.
SaveFormat = ActiveDocument.MailMerge.DataSource.DataFields(“Format”)
  strMsg = strMsg & “4. Opened Word mail merge master document. Time: ” & Now &
vbCrLf
  ‘Perform the merge.
  With ActiveDocument.MailMerge
  .Destination = wdSendToNewDocument
  .Execute
End With
‘Put identification on document so we can tell what server it was created on.
Selection. EndKey Unit:=wdStory
Selection.TypeText Text:=“Created on Dell 2300/450 server ”
Selection.InsertDateTime DateTimeFormat:=“M/d/yy h:mm:ss am/pm”, _{—}
  InsertAsField:=False
Selection.TypeText Text:=“.”
strMsg = strMsg & “5. Performed mail merge. Time: ” & Now & vbCrLf
‘ChangeFileOpenDirectory PhysicalPath & “\”
ChangeFileOpenDirectory “\\hot\hotc\hotdrafts\”
‘ChangeFileOpenDirectory “d:\hotpaperenginetestdrafts\”
    strMsg = strMsg & “6. Deleted any existing version of Word document about to be
saved. Time: ” & Now & vbCrLf
    ‘Save document.
    Select Case SaveFormat
    Case “word97”
        ‘Delete any existing version first.
        If Dir(ResultDoc & ResultDocID & “.doc”) <> “” Then Kill (ResultDoc &
ResultDocID & “.doc”)
        ‘Save file.
        ActiveDocument.SaveAs FileName:=ResultDoc & ResultDocID & “.doc”,
FileFormat:=wdFormatDocument
    Case “word95”
        ‘Delete any existing version first.
        If Dir(ResultDoc & ResultDocID & “.doc”) <> “” Then Kill (ResultDoc &
ResultDocID & “.doc”)
        ‘Save file.
        ActiveDocument.SaveAs FileName:=ResultDoc & ResultDocID & “.doc”,
FileFormat:=11
    Case “works4”
        ‘Delete any existing version first.
        If Dir(ResultDoc & ResultDocID & “.wps <> “” Then Kill (ResultDoc &
ResultDocID & “.wps”)
        ‘Save file.
        ActiveDocument.SaveAs FileName:=ResultDoc & ResultDocID & “.wps”,
FileFormat:=17
    Case “word51mac”
        ‘Delete any existing version first.
        If Dir(ResultDoc & ResultDocID & “.mcw”) <> “” Then Kill (ResultDoc &
ResultDocID & “.mcw”)
        ‘Save file.
        ActiveDocument.SaveAs FileName:=ResultDoc & ResultDocID & “.mcw”,
FileFormat:=14
    Case “rtf”
    ‘Delete any existing version first.
    If Dir(ResultDoc & ResultDocID & “.rtf”) <> “” Then Kill (ResultDoc &
ResultDocID & “.rtf”)
        ‘Save file.
        ActiveDocument.SaveAs FileName:=ResultDoc & ResultDocID & “.rtf”,
FileFormat:=wdFormatRTF
    Case “wp51win”
    ‘Delete any existing version first.
    If Dir(ResultDoc & ResultDocID & “.doc”) <> “” Then Kill (ResultDoc &
ResultDocID & “.doc”)
    ‘Save file.
    ActiveDocument.SaveAs FileName:=ResultDoc & ResultDocID & “.doc”,
FileFormat:=22
    Case “wp51dos”
        ‘Delete any existing version first.
        If Dir(ResultDoc & ResultDocID & “.doc”) <> “” Then Kill (ResultDoc &
ResultDocID & “.doc”)
        ‘Save file.
        ActiveDocument.SaveAs FileName:=ResultDoc & ResultDocID & “.doc”,
FileFormat:=21
    Case “html”
        ‘Delete any existing version first.
        If Dir(ResultDoc & ResultDocID & “.html”) <> “” Then Kill (ResultDoc &
ResultDocID & “.html”)
    ‘Save file.
    ActiveDocument.SaveAs FileName:=ResultDoc & ResultDocID & “.html”,
FileFormat:=10
    Case Else
        ‘Delete any existing version first.
        If Dir(ResultDoc & ResultDocID & “.doc”) <> “” Then Kill (ResultDoc &
ResultDocID & “.doc”)
    ‘Save file.
    ActiveDocument.SaveAs FileName:=ResultDoc & ResultDocID & “.doc”,
FileFormat:=wdFormatDocument
    End Select
‘Dim conv
‘For Each conv In FileConverters
‘ If conv.CanSave Then Debug.Print conv.FormatName & conv.SaveFormat
‘Next conv
    strMsg = strMsg & “7. Saved completed Word mail merge document. Time: ” & Now &
vbCrLf
    strMsg = strMsg & “8. Wrote out HTML link screen. Time: ” & Now & vbCrLf
    ‘Set return value of function.
    ReturnValue = “Word 97 document drafted successfully.”
    drafthot = ReturnValue
    strMsg = strMsg & “9. Set Return Value of function. Time: ” & Now & vbCrLf
Exit_drafthot:
    ‘Close all documents without saving.
    ‘If Documents.Count > 0 Then Documents.Close
SaveChanges:=wdDoNotSaveChanges
    ActiveWindow.Close SaveChanges:=wdDoNotSaveChanges
    ActiveWindow.Close SaveChanges:=wdDoNotSaveChanges
strMsg = strMsg & “10. Closed open documents. Time: ” & Now & vbCrLf
    ‘Write return value to file. This value will be returned to ASP script and will contain word
‘error’ if something went wrong.
    ‘Open WorkPath & “\WWWizWordReturnValue.txt” For Output Access Write Lock
Write As #2
    ‘Print #2, ReturnValue
    ‘Close #2
strMsg = strMsg & “11. Wrote return value to disk. Time: ” & Now & vbCrLf
    ‘Write progress string to file.
    ‘Open WorkPath & “\WWWizWordProgress.txt” For Output Access Write Lock Write As
#2
    ‘Print #2, strMsg
    ‘Close #2
    Debug.Print ReturnValue
    Exit Function
Err_drafthot:
    ‘Set return value of function.
    RetumValue = “ERROR: Word 97 document not drafted. Error Description: “ &
Err.Descnption & ”; Error number: “ & Err.Number & ”; Time: ” & Now
    ‘Write out ReturnValue to debug window.
    Debug.Print ReturnValue
    strMsg = strMsg & “ERROR HANDLER: ” & ReturnValue & vbCrLf
    ‘Exit this function.
    GoTo Exit_drafthot
End Function
```

The job queue 132 can be written as a Visual Basic program, e.g., as list in Table II. Jobs are posted into a pending list or queue. Any wordprocessor program 128 or other application program 130 that is ready to do a job looks at the pending list. If an appropriate job is recognized, its entry in the job queue 132 is moved into an “in-progress” list. The wordprocessor program 128 or other application program 130 then pulls informational pieces it needs from a computer data storage disk 134 and a database 136. The information pieces can also be retrieved in an alternative manner, for example, from a memory location. The job is then executed, and the results in the form of an electronic document are deposited in the disk 134. The Windows-NT 124 then forwards such document to the user 106-112 or the user's designated recipients. When the job is finished, its in-progress entry in the job queue 132 is moved into a “done” list.

TABLE II
(VB Queue)

```
‘ copyright (c) 1999 by Kevin L. Warnock
Private strMasterDoc As Variant
Private strSQL As Variant
Private strField1 As Variant
Private strField2 As Variant
Private strField3 As Variant
Private strField4 As Variant
Private strDSN As Variant
Private strMacro As Variant
Private strSubmitTime As Variant
Private strResultDoc As Variant
Private strResultDocID As Variant
Private strWordVisible As Variant
Private strMyname As String
Private strWorkpath As String
Public Function ReadFromCluster(MachineName)
On Error GoTo Err_ReadFromCluster
  ‘Create variable for central watch directory for work coming in from IIS.
  HotqueuePath = “\\hot\hotc\temp\q\”
  ‘Create variable for directory for documents that are being currently processed by a
Word cluster machine.
  HotqueueDrafting = “\\hot\hotc\temp\d\”
  ‘Create variable for directory where completely finished requests are sent.
  HotqueuePathFinished = “\\hot\hotc\temp\f\”
  ‘Look to see if there are any requests waiting to be processed.
  mypath = HotqueuePath & “*.txt”
  Myname = Dir(mypath)
  strMyname = Myname
  ‘If there is a request, move it to the “in process” directory and read values into property
variables so Word cluster processes can access values.
  If Myname <> “” Then
  ‘To move files, we use filesystemobject from ASP. Cluster machines need ASP so they
can use this command?
  Set fso = CreateObject(“scripting.filesystemobject”)
  Set a = fso.getfile(HotqueuePath & Myname)
  a.Move HotqueueDrafting
  ‘Read contents of request and assign values to property values.
  Open HotqueueDrafting & Myname For Input As #1
  Input #1, strMacroTemplate, strMacroName, strMasterDoc, strResultDoc,
strResultDocID, strDSN, strSQL, strInvokeWord, strDelimitedData, strHeader, strRecord,
strWorkpath, strWordVisible, strField1, strField2, strField3, strField4
  Close #1
  ‘Close file system object.
  Set fso = Nothing
  ‘Assign return value for this function.
  ReadFromCluster = “draft”
Else
‘Assign return value for this function.
  ReadFromCluster = “idle”
End If
Exi_ReadFromCluster:
  Exit Function
Err_ReadFromCluster:
  ReadFromCluster = “Error number: “ & Err.Number & ”, error description: “ &
Err.Description & ”, error source: “ & Err.Source & ”.”
  GoTo Exit_ReadFrom Cluster
End Function
Public Function StatusCluster(WKey)
  ‘After document is drafted, we want to move request
  ‘file from the HotqueueDrafting directory to the
  ‘HotqueuePathFinished directory, since it will be nice
  ‘to be able to examine the in process drafts in
  ‘Windows explorer. Upon successful drafting, the
  ‘request files can be moved to the ‘finished’ directory
  ‘to keep a record of what was done.
‘Pass in WKey, which is the filename of the request
‘file to move.
On Error GoTo Err_StatusCluster
  ‘Create variable for directory for documents that are being currently processed by a Word
cluster machine.
  HotqueueDrafting = “\\hot\hotc\temp\d\”
  ‘Create variable for directory where completely finished requests are sent.
  HotqueuePathFinished = “\\hot\hotc\temp\ff\”
  ‘Look to see if there are any requests waiting to be processed.
  mypath = HotqueueDrafting & WKey
  Myname = Dir(mypath)
  ‘If there is a request, move it to HotqueueDraftng directory and read values
into property variables so Word cluster processes can access values.
  If Myname <> “” Then
  ‘To move files, we use filesystemobject from ASP. Cluster machines need ASP so
they can use this command?
  Set fso = CreateObject(“scripting.filesystemobject”)
  Set a = fso.getfile(HotqueueDrafting & Myname)
  a.Move HotqueuePathFinished
  Set fso = Nothing
  ‘Assign return value for this function.
  StatusCluster = “success”
Else
  ‘Assign return value for this function.
  StatusCluster = “failure”
End If
Exit_StatusCluster:
  Exit Function
Err_StatusCluster:
  StatusCluster = “Error number: “ & Err.Number & ”, error description: “ &
Err.Description & ”, error source: “ & Err.Source & ”.”
  GoTo Exit_StatusCluster
End Function
Public Property Get MasterDoc( ) As String
  MasterDoc = strMasterDoc
End Property
Public Property Get SQL( ) As String
SQL = strSQL
End Property
Public Property Get Macro( ) As String
  Macro = strMacro
End Property
Public Property Get SubmitTime( ) As String
  SubmitTime = strSubmitTime
End Propert
Public Property Get ResultDoc( ) As String
  ResultDoc = strResultDoc
End Property
Public Property Get ResultDocID( ) As String
  ResultDocID = strResultDocID
End Property
Public Property Get WordVisible( ) As String
  WordVisible = strWordVisible
End Property
Public Property Get Field 1( ) As String
  Field 1 = strField1
End Property
Public Property Get Field2( ) As String
  Field2 = strField2
End Property
Public Property Get Field3( ) As String
  Field3 = strField3
End Property
Public Property Get Field4( ) As String
  Field4 = strField4
End Property
Public Property Get DSN( ) As String
  DSN = strDSN
End Property
Public Property Get WorkKey( ) As String
WorkKey = strMyname
End Property
Public Property Get WorkPath( ) As String
  WorkPath = strWorkpath
End Property
```

A “writer” code is invoked from ASP 120, in response to users 106-112, and puts new jobs to do in the job queue 132. A typical source code for this is listed in Table III.

```
TABLE III
‘ copyright (c) 1999 by Kevin L. Warnock
Public Function SubmitToCluster(MacroTemplate, MacroName, MasterDoc, ResultDoc,
ResultDocID, DSN, SQL, InvokeWord, DelimitedData, Header, Record, WorkPath,
WordVisible, Field1, Field2, Field3, Field4)
On Error GoTo Err_SubmitToCluster
  ‘Write text file to pass parameters to Word macro.
  Open “c:\temp\q\” & ResultDoc & ResultDocID & “.txt” For Output As #1
  Write #1, MacroTemplate, MacroName, MasterDoc, ResultDoc, ResultDocID, DSN,
SQL, InvokeWord, DelimitedData, Header, Record, WorkPath, WordVisible, Field,
Field2, Field3, Field4
  Close #1
  SubmitToCluster = “Success”
Exit_SubmitToCluster:
  Exit Function
Err_SubmitToCluster:
  SubmitToCluster = “Error number: “ & Err.Number & ”, error description: “ &
Err.Description & ”, error source: “ & Err.Source & ”.”
  GoTo Exit SubmitToCluster
End Function
```

A system bus 138 in webserver 102 allows expansion through a local area network (LAN) network interface controller (NIC) 140. If the capabilities of the webserver 102 to create documents for the users 106-112 are insufficient because of too great a user demand, a local area network (LAN) 142 can be added-on. Such LAN 142 allows one or more modular expansion units 114 and 116 to be added. The advantage of this is that no extra capacity beyond that which is really necessary must be purchased and installed. Each of the modular expansion units 114 and 116 will access the job queue 132 and look for work to do. Each of the modular expansion units 114 and 116 will pickup metadata and deposit their work products from and to the database 136 and the disk 134.

The LAN 142 is preferably private and inaccessible to the Internet 104 and any of the users 106-112. Standard ETHERNET components can be used to implement LAN 142, NIC 140, and each of a pair of NIC's 144 and 146.

The modular expansion units 114 and 116 replicate a part of the webserver 102 and provide parallel document-creation processing. Each has a Windows-NT operating system 148 and 150. A pair of SRVANY utilities 152 and 154 allow a corresponding set of MS-Word wordprocessor programs 156 and 158 to run as Windows-NT services in parallel with the MSWord 128. Other applications can also be run in parallel as Windows-NT services, and these are represented in FIG. 1 as other applications 160 and 162.

The webserver 102 has been described herein as being completely implemented with various products marketed by Microsoft Corporation, but other similar products from competing suppliers can be used just as well. For example, the webserver 122 may be from Netscape or Apache, the word processor 128 may be from Corel or Lotus, and the operating system 124 may even be Linux rather than Windows NT server. In this case, only word processors designed for Linux, such as WordPerfect from Corel, could be substituted for the word processor 128. The scripting engine ASP 120 may be from Allaire (Cold Fusion), or may be implemented with Java Server Pages, Java Servlets, Perl or Java, among others.

In operation, the users 106-112 are greeted, checked, and screened by another website or portion of this website before being directed to the webserver 102. Such other website allows the users to find, explore, and subscribe to the document-creation services being offered. Once the user 106-112 has qualified as a customer or other authorized user, a document format is selected for use. Such document format will require the user to supply answers to various questions, including information that will be used to fill-in-the-blanks. The answers to the questions, the document-format selection, and the information to fill in the blanks will be transferred in metadata form to the website 102.

Such metadata represents the specifics of a job that needs doing, e.g., a job order. The particulars of the job order are deposited in the database 136. A pointer to this job order and a code representing what kind of job it is are placed in the new job list in the job queue 132. A large selection of standardized “master documents” is stored in the disk 134 and for redundancy and speed, on the local disks of the slave Word machines 114 and 116.

When any of the MS-Word programs 128, 156, and 158, or any of the other applications 130, 160, and 162, “wake-up” from their periodic enforced sleep periods, they each independently check the new job list in the job queue 132 for work that needs doing. If a compatible job that needs doing exists, the application moves the pointer from the new job list to the in-progress list. The pointer data is used as an index to find all the metadata related to the new job that is stored in the database 136. An appropriate master document is fetched from the disk 134 or the local disks of the slave machines, if appropriate. The application then creates the purchased or free document, as many documents may be given away to the public, for the user 106-112 and parks it temporarily in the disk 134. From there it is transmitted to a web-address specified by the user 106-122 in the original job order.

Microsoft Internet Information Server (IIS) is an Internet file and application server included with the Microsoft Windows-NT Server operating system. According to Microsoft, IIS can be used alone as a webserver, or in conjunction with compatible technologies to set up Internet commerce, to access and manipulate data from a variety of data sources, and to build Web applications that take advantage of server script and component code to deliver client-server functionality. The latest information is available on Microsoft's IIS website. IIS provides security, networking, and administration functionality, and has built-in capabilities to help administer secure websites, and to develop and deploy server-intensive Web applications. IIS includes a Web-based administration tool that makes remote administration of webservers possible through use of a Web browser. Users thus have the ability to remotely manage their own sites, safe transmission of data is done with secure sockets layer (SSL).

The IIS is tightly integrated with Windows-NT Server, and so it can utilize many of the management tools within Windows-NT Server to help administer the system, e.g., User Manager for Domains, Performance Monitor, Network Monitor, Event Viewer, and Simple Network Management Protocol (SNMP). In IIS 4.0, it is possible to create an unlimited number of websites on a single IP address, and to have different configuration information for each one. This has been challenging in the past, because each IP address could have only one domain name. The Internet Engineering Task Force's HTTP 1.1 allows multiple domain names on one IP-address by specifying the host header information that gets a user to the right website. IIS comes with the support necessary for those browsers to access sites. When multiple websites are enabled on one machine, IIS 4.0 provides users the ability to manage how much network bandwidth is provided to each website. Such “bandwidth throttling” ensures enough bandwidth is made available to each of the sites on the machine. Sites that publish static HTML pages, e.g., “.htm” files, can take full advantage of bandwidth throttling in IIS.

The Windows-NT 4.0 Option Pack includes Microsoft Site Server Express, so site administrators can analyze server log files and produce reports that detail user behavior, analyzes site content and correct errors, and publishes webpages to local and remote servers.

When secure transactions are required over the Internet, IIS and Windows-NT Server provide support for Secure Sockets Layer 3.0 (SSL), enabling information to be exchanged between clients and servers. SSL 3.0 provides a way for the server to verify who the client is through the use of digital certificates, without requiring a server logon. IIS issues and manages these certificates through Microsoft Certificate Server, and maps them to user accounts on a machine that gives the user the correct level of access to files and services. Windows-NT Server and IIS also support basic authentication, sending of unencrypted user names and passwords, Challenge/Response cryptographic authentication of passwords), and server-gated crypto 128-bit encryption for digital certificates used in transactions with banks and other financial institutions.

Transaction support in Windows-NT Server and IIS is implemented through Microsoft Transaction Server (MTS) 2.0 and tracks the success or failure of complete system processes, such as ordering or accessing and manipulating data. When ASP pages are declared to be transactional, Transaction Server handles the details of creating the defined transactions that occur within the page. Transaction components are activated when needed and deactivated when not in use to save system resources. MTS management is also controlled through the Microsoft Management Console.

An OLE-type control enables developers to create Microsoft Visual Basic applications that will function as Windows-NT services. With the NTService control, users can install a service, log events, and respond to start, stop, pause, and continue events. The operating system interface for services requires a callback function and blocks the main thread of execution. Because Visual Basic 4.0 has neither threads nor callback functions, developers cannot call these application programming interfaces (APIs) directly. Visual Basic applications can rely on the SRVANY utility provided in the Windows-NT Resource Kit which allows any executable to be started by the system at boot time. However, the communication between SRVANY and the application is limited to standard window messages, so such solution is not very robust. Moreover, SRVANY lacks support for the pause and continue functions.

An NTService OLE control could alternatively be used to eliminate the need for a helper processes like SRVANY utility 126 by enabling Visual Basic applications to directly interface with the services' APIs. Such OLE control translates signals from the operating system into events that can be processed by a Visual Basic application. It also provides support for functions that services typically require, such as installation and event logging. Creating a service begins by dropping the NTService control on a form. Services typically do not have any user interface, but in Visual Basic the control needs a form to serve as a container. At a minimum, users will need to set some properties and implement the installation routine and handlers for the Start and Stop events.

Many of the details of creating services in C or C++ are well documented and various examples assume that the entire application is designed around the Windows-NT service framework defined by the Win32 APIs. The NTService control must bridge the services' interfaces with the Visual Basic application model. During initialization, services call the StartServiceCtrlDispatcher API, passing a callback function that is used by the service controller for service initialization. The control cannot call the dispatcher function in a method because this function blocks the caller until the service is stopped. To solve this problem, the control creates a separate thread that is responsible for calling the dispatcher. This allows the primary thread used by Visual Basic to continue processing while the other thread is blocked by the service's dispatcher.

While the application is running as a service, events will fire from the service thread and the control request handler. Both of these functions execute on different thread contexts from the Visual Basic code. Because Visual Basic is not thread-safe, the apartment-model OLE control rules specify that all calls must occur in the same thread where the object was created. The effect on the NTService control is that it must transfer execution to the primary thread in order to generate notification events. This is done by posting window messages to the control's invisible window and letting the window message dispatch loop inside Visual Basic transfer execution to the control.

The control's window is critical to the routing of messages from the service's dispatcher to the Visual Basic application. Because OLE control containers have some discretion as to when the control window is created, the control informs the container that the window must exist always. This is done by marking the control with the OLEMISC_SIMPLEFRAME attribute and enabling the simple frame interface in the control constructor.

Even though an application is running as a service it does not mean that it can handle the processing requirements of application servers such as Microsoft SQL Server or Microsoft Exchange Server. Visual Basic services are single-threaded and do not expose programming interfaces. The Distributed Component Object Model (DCOM) in Windows-NT version 4.0 allows the service to be callable through OLE Automation interfaces locally or from a remote computer.

According to Microsoft, this type of service can be used to augment application servers. For example, if users need to capture a real-time data broadcast in a SQL database, the Windows-NT service support can be added to make the application easier to administer. Likewise, users could write Microsoft Exchange Server mailbox agents in a higher-level language, taking advantage of existing components, such as OLE Messaging, to simplify development.

The NTService control lets developers create Visual Basic applications that install and run as Windows-NT services. These applications benefit from automatic startup, remote administration, and event logging.

Active Server Pages is a programming environment for combining HTML, scripting, and components to create Internet applications that run on the server. If users are already creating websites that combine HTML, scripting, and some reusable components, users can use ASP to glue these items together. Users can create an HTML interface for the application by adding script commands to the HTML pages and users can encapsulate the business logic into reusable components. These components can be called from script or other components.

Microsoft Active Server Pages (ASP) is a server-side scripting environment that users can use to create dynamic webpages or to build Web applications. ASP pages are files that contain HTML tags, text, and script commands. ASP pages can call ActiveX components to perform tasks, such as connecting to a database or performing a business calculation. With ASP, users can add interactive content to the webpages or build entire Web applications that use HTML pages as the interface to the customer.

When ASP is incorporated into a website, a user is allowed to bring up the website where a default page has the extension “.asp”. The user's browser requests the ASP file from the webserver. A server-side script begins to run with ASP. The requested file is processed top-down by ASP, executing any script commands contained in the file. An HTML webpage is produced as a result and is sent to the user's browser. Because such script runs on the server, the webserver does all of the processing so standard HTML pages can be generated and sent to the browser. The webpages are limited only by what the webserver supports. Another benefit of having the script reside on the server is that the user cannot “view source” on the original script and code. Instead, the user sees only the generated HTML as well as non-HTML content, such as XML, on the pages that are being viewed.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is:

1. A document-creation system, comprising:
a webserver for interfacing to the Internet and a plurality of remote network users and browsers, and including a network operating system that can call a variety of server processes, and an active server page process that provides interactive webpages for each of said remote network users and browsers;
a database included in the website and for receiving metadata from said plurality of remote network users and browsers needed to create a plurality of user documents;
a disk included in the website and including a selection of master documents needed to create said plurality of user documents;
at least one application program for merging a particular piece of said metadata and a selected one of said master documents; and
a job queue for providing scheduling of the application programs according to said metadata and selected ones of said master documents;
wherein, the application programs create said plurality of user documents from copies of said master documents and metadata and a product is returned to corresponding ones of said plurality of remote network users and browsers.

2. The document-creation system of claim 1, wherein:
the job queue and application programs are such that each application program periodically and independently checks the job queue for work.

3. The document-creation system of claim 1, wherein:
the job queue and application programs are such that each application program puts itself to sleep for a period of time if the job queue has no work.

4. The document-creation system of claim 1, further comprising:
a utility for providing an interface between said network operating system and the application programs that allow the application programs to run as server processes.

5. The document-creation system of claim 1, further comprising:
a local area network (LAN) connected to the network operating system and for providing a backend expansion backbone for additional application programs.

6. The document-creation system of claim 6, wherein:
the LAN is not directly accessible from the Internet.

7. The document-creation system of claim 1, wherein:
at least one of the application programs is a wordprocessor program that includes a macro capability and macro instructions that puts the application program to sleep for a period of time if the job queue has no work.

8. The document-creation system of claim 1, wherein:
the job queue is implemented with a VISUAL BASIC program and includes a job-waiting list, a job-in-progress list, and a job-done list.

9. The document-creation system of claim 8, wherein:
the webserver further includes an Internet information server connected to said active server page process that supplies said metadata to the database and a pointer to said metadata in the database that is placed in said job-waiting list.

10. The document-creation system of claim 9, wherein:
said VISUAL BASIC program causes said pointer to be moved from said job-waiting list to said job-in-progress list when of one of the application programs has been assigned a corresponding job.

11. The document-creation system of claim 9, wherein:
said VISUAL BASIC program causes said pointer to be moved from said job-in-progress list to said job-done list when said one of the application programs has completed a corresponding job.
